(19) United States
(12) Patent Application Publication
(10) Pub. No.: US 2024/0284226 A1
(43) Pub. Date: Aug. 22, 2024

(54) METHOD AND DEVICE FOR EVENT TRIGGERED MEASUREMENT REPORTING

(71) Applicant: FG Innovation Company Limited, Tuen Mun (HK)

(72) Inventors: CHIA-HSIN LAI, Taipei (TW); MEI-JU SHIH, Taipei (TW); CHIA-HUNG LIN, Taipei (TW); WAN-CHEN LIN, Taipei (TW)

(21) Appl. No.: 18/444,727

(22) Filed: Feb. 18, 2024

Related U.S. Application Data
(60) Provisional application No. 63/446,673, filed on Feb. 17, 2023.

(51) Int. Cl. H04W 24/10; H04L 5/00; H04W 72/21; H04W 72/542

(52) U.S. Cl. CPC H04W 24/10; H04L 5/0035; H04W 72/21; H04W 72/542

(57) ABSTRACT

Methods and devices for event triggered measurement reporting are provided. The method includes determining whether a specific scheduling request (SR) configuration is configured to the UE. In a case that the specific SR configuration is configured to the UE, the method transmits, to a base station (BS), an SR according to the specific SR configuration in response to a fulfillment of a condition. The method receives, from the BS, downlink control information (DCI) indicating a first uplink (UL) resource for transmitting a measurement report, and transmits, to the BS, the measurement report on the first UL resource.

### CROSS-REFERENCE TO RELATED APPLICATION(S)

The present disclosure claims the benefit of and priority to U.S. Provisional Patent Application Ser. No. 63/446,673, filed on Feb. 17, 2023, entitled “METHOD AND APPARATUS TO ENHANCE L1 L2 TRIGGERED MOBILITY,” the content of which is hereby incorporated herein fully by reference into the present disclosure for all purposes.

### FIELD

The present disclosure generally relates to wireless communications and, more particularly, to methods and devices for event triggered measurement reporting.

### BACKGROUND

Various efforts have been made to improve different aspects of wireless communication for cellular wireless communication systems, such as 5^{th} Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to grow, there is a need for further improvements in wireless communication in the next-generation wireless communication systems.

### SUMMARY

The present disclosure is directed to methods and devices for event triggered measurement reporting.

According to a first aspect of the present disclosure, a method performed by a User Equipment (UE) is provided. The method includes determining whether a specific scheduling request (SR) configuration is configured to the UE; in a case that the specific SR configuration is configured to the UE, transmitting, to a base station (BS), an SR according to the specific SR configuration in response to a fulfillment of a condition; receiving, from the BS, downlink control information (DCI) indicating a first uplink (UL) resource for transmitting a measurement report; and transmitting, to the BS, the measurement report on the first UL resource.

In some implementations of the first aspect of the present disclosure, the specific SR configuration is associated with a Layer 1/Layer 2 (L1/L2) Triggered Mobility (LTM) mechanism.

In some implementations of the first aspect of the present disclosure, the specific SR configuration comprises an SR configuration for event triggered measurement reporting.

In some implementations of the first aspect of the present disclosure, the method further includes determining whether the first UL resource overlaps with a second UL resource that is configured to the UE for transmitting a content; and in a case that the first UL resource overlaps with the second UL resource, transmitting, to the BS, the measurement report, the content, or a multiplexing of the measurement report and the content on the first UL resource or the second UL resource.

In some implementations of the first aspect of the present disclosure, the condition is associated with a non-filtered Layer 1 measurement result with respect to a serving cell.

In some implementations of the first aspect of the present disclosure, the condition is fulfilled in a case that the measurement result indicates that a signal quality of at least one candidate cell is better than a signal quality of the serving cell.

In some implementations of the first aspect of the present disclosure, the condition is fulfilled in a case that the measurement result indicates that a signal quality of at least one candidate cell exceeds a signal quality of the serving cell by more than a predetermined threshold.

In some implementations of the first aspect of the present disclosure, the condition is fulfilled in a case that the measurement result indicates that a signal quality of the serving cell is worse than a predetermined threshold.

According to a second aspect of the present disclosure, a UE is provided. The UE includes one or more non-transitory computer-readable media storing one or more computer-executable instructions; and at least one processor coupled to the one or more non-transitory computer-readable media. The at least one processor configured to execute the one or more computer-executable instructions to cause the UE to determine whether a specific SR configuration is configured to the UE; in a case that the specific SR configuration is configured to the UE, transmit, to a BS, an SR according to the specific SR configuration in response to a fulfillment of a condition; receive, from the BS, DCI indicating a first UL resource for transmitting a measurement report; and transmit, to the BS, the measurement report on the first UL resource.

In some implementations of the second aspect of the present disclosure, the specific SR configuration is associated with an LTM mechanism.

In some implementations of the second aspect of the present disclosure, the specific SR configuration comprises an SR configuration for event triggered measurement reporting.

In some implementations of the second aspect of the present disclosure, the at least one processor is configured to execute the one or more computer-executable instructions to further cause the UE to determine whether the first UL resource overlaps with a second UL resource that is configured to the UE for transmitting a content on the second UL resource; and in a case that the first UL resource overlaps with the second UL resource, transmit, to the BS, the measurement report, the content, or a multiplexing of the measurement report and the content on the first UL resource or the second UL resource.

In some implementations of the second aspect of the present disclosure, the condition is associated with a non-filtered Layer 1 measurement result with respect to a serving cell.

In some implementations of the second aspect of the present disclosure, the condition is fulfilled in a case that the measurement result indicates that a signal quality of at least one candidate cell is better than a signal quality of the serving cell.

In some implementations of the second aspect of the present disclosure, the condition is fulfilled in a case that the measurement result indicates that a signal quality of at least one candidate cell exceeds a signal quality of the serving cell by more than a predetermined threshold.

In some implementations of the second aspect of the present disclosure, the condition is fulfilled in a case that the measurement result indicates that a signal quality of the serving cell is worse than a predetermined threshold.

According to a third aspect of the present disclosure, a BS is provided. The BS includes one or more non-transitory computer-readable media storing one or more computer-executable instructions; and at least one processor coupled to the one or more non-transitory computer-readable media, the at least one processor configured to execute the one or more computer-executable instructions to cause the BS to transmit, to a UE, a specific SR configuration; receive, from the UE, an SR associated with the specific SR configuration; transmit, to the UE, DCI indicating a first UL resource for receiving a measurement report in response to a reception of the SR associated with the specific SR configuration; and receive, from the UE, the measurement report on the first UL resource.

In some implementations of the third aspect of the present disclosure, the specific SR configuration is associated with an LTM mechanism.

In some implementations of the third aspect of the present disclosure, the specific SR configuration comprises an SR configuration for event triggered measurement reporting.

In some implementations of the third aspect of the present disclosure, the at least one processor is configured to execute the one or more computer-executable instructions to further cause the BS to transmit, to the UE, a configuration of a second UL resource for transmitting a content; and in a case that the first UL resource overlaps with the second UL resource, receive, from the UE, the measurement report, the content, or a multiplexing of the measurement report and the content on the first UL resource or the second UL resource.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a flowchart for a method of event triggering measurement reporting, according to an example implementation of the present disclosure.

FIG. 2 is a block diagram illustrating a node for wireless communication, according to an example implementation of the present disclosure.

### DETAILED DESCRIPTION

The following description contains specific information pertaining to example implementations in the present disclosure. The drawings in the present disclosure and their accompanying detailed description are directed to merely example implementations. However, the present disclosure is not limited to merely these example implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not shown) by the same numerals in the example figures. However, the features in different implementations may be differed in other respects, and thus shall not be narrowly confined to what is shown in the figures.

The description uses the phrase “in some implementations,” which may refer to one or more of the same or different implementations. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series and the equivalent. The expression “at least one of A, B and C,” “at least one of the following: A, B and C,” “at least one of A, B or C,” and “at least one of the following: A, B or C” means “only A, or only B, or only C, or any combination of A, B and C.”

Additionally, for the purposes of explanation and non-limitation, specific details, such as functional entities, techniques, protocols, standard, and the like are set forth for providing an understanding of the described technology. In other examples, detailed description of well-known methods, technologies, systems, architectures, and the like are omitted so as not to obscure the description with unnecessary details.

Persons skilled in the art will immediately recognize that any NW function(s) or algorithm(s) described in the present disclosure may be implemented by hardware, software, or a combination of software and hardware. Described functions may correspond to modules which may be software, hardware, firmware, or any combination thereof. The software implementation may include computer executable instructions stored on computer readable medium, such as a memory or other types of storage devices. For example, one or more microprocessors or general-purpose computers with communication processing capability may be programmed with corresponding executable instructions and carry out the described NW function(s) or algorithm(s). The microprocessors or general-purpose computers may be formed of Application-Specific Integrated Circuits (ASICs), programmable logic arrays, and/or one or more Digital Signal Processor (DSPs). Although some of the example implementations described in this specification are oriented to software installed and executing on computer hardware, nevertheless, alternative example implementations implemented as firmware, as hardware, or as a combination of hardware and software are well within the scope of the present disclosure.

The computer readable medium includes, but is not limited to, Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a Long Term Evolution (LTE) system, an LTE-Advanced (LTE-A) system, an LTE-Advanced Pro system, or a 5G New Radio (NR) Radio Access Network (RAN)) typically includes at least one Base Station (BS), at least one User Equipment (UE), and one or more optional NW elements that provide connection toward the NW. The UE communicates with the NW (e.g., a Core Network (CN), an Evolved Packet Core (EPC) NW, an Evolved Universal Terrestrial Radio Access Network (E-UTRAN), a 5G Core (5GC), or an internet), through a RAN established by one or more BSs.

It should be noted that, in the present application, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access NW.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic Wideband-Code Division Multiple Access (W-CDMA), High-Speed Packet Access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved Node B (eNB) as in the LTE or LTE-A, a Radio Network Controller (RNC) as in the UMTS, a Base Station Controller (BSC) as in the GSM/GERAN, a ng-eNB as in an Evolved Universal Terrestrial Radio Access (E-UTRA) BS in connection with the 5GC, a next-generation Node B (gNB) as in the 5G-RAN, and any other apparatus capable of controlling radio communication and managing radio resources within a cell. The BS may serve one or more UEs through a radio interface.

The BS is operable to provide radio coverage to a specific geographical area using multiple cells forming the radio access NW. The BS supports the operations of the cells. Each cell is operable to provide services to at least one UE within its radio coverage. More specifically, each cell (often referred to as a serving cell) provides services to serve one or more UEs within its radio coverage (e.g., each cell schedules the downlink (DL) and optionally uplink (UL) resources to at least one UE within its radio coverage for DL and optionally UL packet transmissions). The BS may communicate with one or more UEs in the radio communication system through the plurality of cells. A cell may allocate Sidelink (SL) resources for supporting Proximity Service (ProSe) or Vehicle to Everything (V2X) service. Each cell may have overlapped coverage areas with other cells.

As discussed above, the frame structure for NR is to support flexible configurations for accommodating various next-generation (e.g., 5G) communication requirements, such as Enhanced Mobile Broadband (eMBB), Massive Machine Type Communication (mMTC), Ultra-Reliable and Low-Latency Communication (URLLC), while fulfilling high reliability, high data rate and low latency requirements. The Orthogonal Frequency-Division Multiplexing (OFDM) technology as agreed in the 3^{rd} Generation Partnership Project (3GPP) may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a DL transmission data, a guard period, and an UL transmission data should at least be included, where the respective portions of the DL transmission data, the guard period, and the UL transmission data should also be configurable, for example, based on the NW dynamics of NR. In addition, SL resources may also be provided in an NR frame to support ProSe services or V2X services.

In addition, the terms “system” and “NW” herein may be used interchangeably. The term “and/or” herein is only an association relationship for describing associated objects, and represents that three relationships may exist. For example, A and/or B may indicate that A exists alone, A and B exist at the same time, or B exists alone. In addition, the character “/” herein generally represents that the former and latter associated objects are in an “or” relationship. Multiple PLMNs may operate on the unlicensed spectrum. Multiple PLMNs may share the same unlicensed carrier. The PLMNs may be public or private. Public PLMNs may be (but not limited to) the operators or virtual operators, which provides radio services to the public subscribers. Public PLMNs may own the licensed spectrum and support the radio access technology on the licensed spectrum as well. Private PLMNs may be (but not limited to) the micro-operators, factories, or enterprises, which provides radio services to its private users (e.g., employees or machines). In some implementations, public PLMNs may support more deployment scenarios (e.g., carrier aggregation between licensed band NR (PCell) and NR-U (SCell), dual connectivity between licensed band LTE (PCell) and NR-U (PSCell), stand-alone NR-U, an NR cell with DL in unlicensed band and UL in licensed band, dual connectivity between licensed band NR (PCell) and NR-U (PSCell)). In some implementations, private PLMNs mainly support (but not limited to) the stand-alone unlicensed radio access technology (e.g., stand-alone NR-U).

Some of the terms, definitions, and abbreviations, as given in this disclosure, are either found in existing documentation (European Telecommunications Standards Institute (ETSI), International Telecommunication Union (ITU), etc.) or may have been newly created by the 3GPP experts, for example, in the case that there was a need for a precise vocabulary.

A UE may transmit a Channel State Information (CSI) report to the UE's serving cell/gNB. The CSI report may include at least one of: Channel Quality Indicator (CQI), precoding matrix indicator (PMI), CSI Reference Signal (CSI-RS) Resource Indicator (CRI), Synchronization Signal (SS)/Physical Broadcast CHannel (PBCH) Block Resource indicator (SSBRI), layer indicator (LI), rank indicator (RI), Layer 1 Reference Signal Received Power (L1-RSRP), Layer 1 Signal to Interference plus Noise Ratio (L1-SINR) and CapabilityIndex. In addition, several report types of CSI report may be included, such as periodic, semiPersistentOnPUCCH, semiPersistentOnPUSCH, and aperiodic. The time and frequency resources available for the UE to report the CSI may be controlled by the network.

For CQI, PMI, CRI, SSBRI, LI, RI, L1-RSRP, L1-SINR, CapabilitySetIndex, CapabilityIndex, a UE may be configured by higher layers with N≥1 CSI-ReportConfig Reporting Settings, M≥1 CSI-ResourceConfig Resource Settings, and one or two list(s) of trigger states. The one or two list(s) of trigger states may be given by the higher layer parameters such as the CSI-AperiodicTriggerStateList and the CSI-SemiPersistentOnPUSCH-TriggerStateList.

Each trigger state in the CSI-AperiodicTriggerStateList may contain a list of associated the CSI-ReportConfigs, the list of associated the CSI-ReportConfigs may indicate the Resource Set IDs for channel and optionally for interference. Each trigger state in the CSI-SemiPersistentOnPUSCH-TriggerStateList may contain one associated the CSI-ReportConfig.

Each Reporting Setting the CSI-ReportConfig may be associated with a single downlink BandWidth Part (BWP) (e.g., which may be indicated by higher layer parameter BWP-Id) given in the associated the CSI-ResourceConfig for channel measurement. Each Reporting Setting CSI-ReportConfig may contain parameter(s) for one CSI reporting band, where said parameter(s) may indicate at least one of: codebook configuration including codebook subset restriction, time-domain behavior, frequency granularity for CQI and PMI, measurement restriction configurations, and the CSI-related quantities to be reported by the UE, such as the layer indicator (LI), L1-RSRP, L1-SINR, CRI, and SSBRI and Capability[Set]Index.

The time domain behavior of the CSI-ReportConfig may be indicated by a higher layer parameter, such as the reportConfigType, and the higher layer parameter may be set to “aperiodic”, “semiPersistentOnPUCCH”, “semiPersistentOnPUSCH”, or “periodic”. For CSI reporting with report types of “periodic”, “semiPersistentOnPUCCH”, and “semiPersistentOnPUSCH”, the configured periodicity and slot offset may apply in the numerology of the UL BWP in which the CSI report may be configured to be transmitted.

The higher layer parameter reportQuantity may indicate the CSI-related, L1-RSRP-related, L1-SINR-related, or Capability[Set]Index-related quantities to be reported.

The higher layer parameter reportFreqConfiguration may indicate the reporting granularity in the frequency domain, including the CSI reporting band and whether the reporting of PMI/CQI is conducted on a wideband or a sub-band basis.

The timeRestrictionForChannelMeasurements parameter in the CSI-ReportConfig may be configured to enable time domain restriction for channel measurements and the timeRestrictionForInterferenceMeasurements parameter in the CSI-ReportConfig may be configured to enable time domain restriction for interference measurements. The CSI-ReportConfig may also contain a CodebookConfig, which may contain configuration parameters for Type-I, Type II, Enhanced Type II CSI, or Further Enhanced Type II Port Selection including codebook subset restriction when applicable, and configurations of group-based reporting.

Each CSI Resource Setting CSI-ResourceConfig may contain a configuration of a list of S≥1 CSI Resource Sets (e.g., given by a higher layer parameter csi-RS-ResourceSetList). The list may include references to either or both of Non-Zero Power (NZP) CSI-RS resource set(s) and SS/PBCH block set(s) or may include references to the CSI Interference Measurement (CSI-IM) resource set(s). Each CSI Resource Setting may be associated with a DL BWP identified by a higher layer parameter BWP-id, and all CSI Resource Settings associated with the same CSI Report Setting may be associated with the same DL BWP.

The time domain behavior of the CSI-RS resources within a CSI Resource Setting may be indicated by a higher layer parameter, such as the resourceType, and the higher layer parameter may be set to aperiodic, periodic, or semi-persistent.

For periodic and semi-persistent CSI Resource Settings, in a case that the UE is configured with the groupBasedBeamReporting-r17, the number of configured CSI Resource Sets may be S=2; otherwise, the number of configured CSI-RS Resource Sets may be limited to S=1.

For periodic and semi-persistent CSI Resource Settings, the configured periodicity and slot offset may be given in the numerology of its associated DL BWP, such as given by the BWP-id.

When a UE is configured with multiple CSI-ResourceConfigs, including the same Non Zero Power (NZP) CSI-RS resource ID, the same time domain behavior may be configured for the CSI-ResourceConfigs. When a UE is configured with multiple CSI-ResourceConfigs, including the same CSI-IM resource ID, the same time-domain behavior may be configured for the CSI-ResourceConfigs. All CSI Resource Settings linked to a CSI Report Setting may have the same time domain behavior.

The following may be configured via higher layer signaling for one or more CSI Resource Settings for channel and interference measurement:
a CSI-IM resource for interference measurement;
an NZP CSI-RS resource for interference measurement; and
an NZP CSI-RS resource for channel measurement.

The UE may assume that the NZP CSI-RS resource(s) for channel measurement and the CSI-IM resource(s) for interference measurement configured for one CSI reporting are resource-wise Quasi Co-Located (QCLed) with respect to “typeD”. In a case that NZP CSI-RS resource(s) are used for interference measurement, the UE may assume that the NZP CSI-RS resource for channel measurement and the CSI-IM resource, or NZP CSI-RS resource(s) for interference measurement configured for one CSI reporting, are QCLed with respect to “typeD”.

For L1-SINR measurement:
When one Resource Setting is configured, the Resource Setting (e.g., given by a higher layer parameter resourcesForChannelMeasurement) may be for channel and interference measurement on an NZP CSI-RS for L1-SINR computation. The UE may assume that the same 1 port NZP CSI-RS resource(s) with a density of 3 Resource Elements (Res)/Resource Block (RB) is used for both channel and interference measurements.
When two Resource Settings are configured, the first Resource Setting (e.g., given by a higher layer parameter resourcesForChannelMeasurement) may be for the channel measurement on SSB or NZP CSI-RS, and the second Resource Setting (e.g., given by a higher layer parameter csi-IM-ResourcesForInterference or nzp-CSI-RS-ResourcesForInterference) may be for the interference measurement performed on CSI-IM or on 1 port NZP CSI-RS with a density of 3 REs/RB, where each SSB or NZP CSI-RS resource for channel measurement may be associated with one CSI-IM resource or one NZP CSI-RS resource for interference measurement. The number of SSB(s) or CSI-RS resources for channel measurement may equal to the number of CSI-IM resources or the number of NZP CSI-RS resources for interference measurement.

In some implementations, the UE may expect that the NZP CSI-RS resource set for channel measurement and the NZP-CSI-RS resource set for interference measurement, if any, may be configured with the higher layer parameter repetition.

A UE may perform aperiodic CSI reporting using PUSCH on the UE's serving cell upon successful decoding of a DCI format 0_1 or a DCI format 0_2 which may trigger an aperiodic CSI trigger state.

In a case that the DCI format 0_1 schedules two PUSCH allocations, the aperiodic CSI report may be carried on the second scheduled PUSCH. In a case that a DCI format 0_1 schedules more than two PUSCH allocations, the aperiodic CSI report is carried on the penultimate scheduled PUSCH.

The aperiodic CSI reporting on the PUSCH may support wideband and sub-band frequency granularities. The aperiodic CSI reporting on the PUSCH may support Type I, Type II, Enhanced Type II and Further Enhanced Type II Port Selection CSI.

A UE may perform semi-persistent CSI reporting using a PUSCH upon successful decoding of a DCI format 0_1 or a DCI format 0_2, which may activate a semi-persistent CSI trigger state. Specifically, the DCI format 0_1 and the DCI format 02 may contain a CSI request field, which may indicate activation or deactivation of the semi-persistent CSI trigger state.

The Semi-persistent CSI reporting on the PUSCH may support Type I, Type II with wideband and sub-band frequency granularities, Enhanced Type II and Further Enhanced Type II Port Selection CSI. The PUSCH resources and Modulation and Coding Scheme (MCS) may be allocated semi-persistently by an uplink DCI (e.g., DCI scheduling PUSCH(s)).

In some implementations, the CSI reporting on the PUSCH may be multiplexed with uplink data, with the exception that semi-persistent CSI reporting on the PUSCH activated by a DCI format is not expected to be multiplexed with uplink data. In some implementations, the CSI reporting on the PUSCH may be performed without multiplexing with any uplink data from the UE.

Type I CSI feedback may be supported for CSI Reporting on a PUSCH. Type I wideband and sub-band CSI may be supported for CSI Reporting on the PUSCH. Type II CSI may be supported for CSI Reporting on the PUSCH.

For Type I, Type II, Enhanced Type II and Further Enhanced Type II Port Selection CSI feedback on the PUSCH, a CSI report may include two parts. Part 1 may have a fixed payload size and be used to identify the number of information bits in Part 2. Part 1 may be transmitted in its entirety before Part 2.
For Type I CSI feedback, Part 1 may contain RI (if reported), CRI (if reported), and CQI for the first codeword (if reported); and Part 2 may contain PMI (if reported) and LI (if reported). In a case that RI is larger than 4, Part 2 may contain the CQI for the second codeword (if reported).

For the CSI-ReportConfig configured with a codebookType set to “typeI-SinglePanel” and the corresponding CSI-RS Resource Set for channel measurement configured with two Resource Groups and N Resource Pairs, Part 1 may contain RI(s), CRI(s), and CQI(s) for the first codeword and be zero padded to a fixed payload size (if needed); and Part 2 may contain the CQI(s) for the second codeword (if reported) when RI is larger than 4 LIs (if reported), and PMI(s).
For Type II CSI feedback, Part 1 may contain RI (if reported), CQI, and an indication of the number of non-zero wideband amplitude coefficients per layer for the Type II CSI. The fields of Part 1 (e.g., RI (if reported), CQI, and the indication of the number of non-zero wideband amplitude coefficients for each layer, as described previously) may be separately encoded. Part 2 may contain the PMI and LI (if reported) of the Type II CSI.
For Enhanced Type II CSI feedback and Further Enhanced Type II Port Selection CSI feedback, Part 1 may contain RI (if reported), CQI, and an indication of the overall number of non-zero amplitude coefficients across layers. The fields of Part 1 (e.g., RI (if reported), CQI, and the indication of the overall number of non-zero amplitude coefficients across layers, as previously described) may be separately encoded. Part 2 may contain the PMI of the Enhanced Type II or Further Enhanced Type II Port Selection CSI. In addition, Part 1 and Part 2 may be separately encoded.

A Type II CSI report carried on the PUSCH may be computed independently from any Type II CSI report carried on the PUCCH formats 3 or 4.

In some implementations, when a higher layer parameter reportQuantity is configured with one of the following values: “cri-RSRP”, “ssb-Index-RSRP”, “cri-SINR”, “ssb-Index-SINR”, “cri-RSRP-Capability[Set]Index”, “ssb-Index-RSRP-Capability[Set]Index”, “cri-SINR-Capability[Set]Index”, “ssb-Index-SINR-Capability[Set]Index”, the CSI feedback may include a single part.

For both Type I and Type II reports configured for a PUCCH, but transmitted on a PUSCH, the determination of the payload for Part 1 CSI and Part 2 CSI may follow the configuration of the PUCCH.

In a case that the semi-persistent CSI reporting on the PUSCH is configured to the UE and is active, the CSI reporting may be deactivated when either the downlink BWP or the uplink BWP is changed. As such, another activation command may be required to enable the semi-persistent CSI reporting.

A UE may be semi-statically configured by higher layers to perform periodic CSI Reporting on the PUCCH. A UE may be configured by higher layers for multiple periodic CSI Reports corresponding to multiple CSI Reporting Settings configured by higher layers, where the associated CSI Resource Settings may be configured by higher layers. Periodic CSI reporting on the PUCCH formats 2, 3, 4 may support Type I CSI with wideband granularity.

A UE may perform semi-persistent CSI reporting on the PUCCH that is applied starting from the first slot that is after slot n+3Nₛₗₒₜ^{subframe,μ}, where the UE may transmit a PUCCH with the HARQ-ACK information in slot n and the HARQ-ACK information may be corresponding to the PDSCH carrying an activation command. The activation command may contain one or more Reporting Settings where the associated CSI Resource Settings are configured.

Semi-persistent CSI reporting on the PUCCH may support Type I CSI. Semi-persistent CSI reporting on the PUCCH format 2 may support Type I CSI with wideband frequency granularity. Semi-persistent CSI reporting on the PUCCH formats 3 or 4 may support Type I CSI with wideband and sub-band frequency granularities and Type II CSI Part 1.

In some implementations, when the PUCCH carries Type I CSI with wideband frequency granularity, the CSI payload carried by the PUCCH format 2 and PUCCH format 3 or 4 may be identical (and the same), irrespective of the RI (if reported) and CRI (if reported).

A CSI-ReportConfig with a codebookType set to “typeI-SinglePanel” and the corresponding CSI-RS Resource Set for channel measurement configured with two Resource Groups and N Resource Pairs may be configured with wideband frequency granularity only when the csi-ReportMode is set to “Model” and the numberOfSingleTRP-CSI-Model is set to X=0.

For type I CSI sub-band reporting on the PUCCH formats 3, or 4, the payload may be split into two parts. Part 1 may contain the RI (if reported), CRI (if reported), and CQI for the first codeword. Part 2 may contain the PMI (if reported) and LI (if reported). Part 2 may further contain the CQI for the second codeword (if reported) when the RI>4.

For the CSI-ReportConfig configured with subband reporting, the codebookType set to “typeI-SinglePanel” and the corresponding CSI-RS Resource Set for channel measurement configured with two Resource Groups and N Resource Pairs, Part 1 may contain the RI(s), CRI(s), CQI(s) for the first codeword and may be zero padded to a fixed payload size (if needed); and Part 2 may contain the CQI(s) for the second codeword (if reported) when the RI is larger than 4, the LIs (if reported) and the PMI(s).

A semi-persistent report carried on the PUCCH formats 3 or 4 may support Type II CSI feedback, but only Part 1 of the Type II CSI feedback may be supported. Supporting Type II CSI reporting on the PUCCH formats 3 or 4 may be a UE capability (e.g., type2-SP-CSI-Feedback-LongPUCCH). A Type II CSI report (e.g., Part 1 only) carried on the PUCCH formats 3 or 4 may be calculated independently of any Type II CSI reports carried on the PUSCH.

In some implementations, when the UE is configured with CSI Reporting on the PUCCH formats 2, 3, or 4, each PUCCH resource may be configured for a candidate UL BWP.

In a case that semi-persistent CSI reporting on the PUCCH is configured to a UE and is active, and a deactivation command has not been received by the UE, the CSI reporting may occur when the BWP configured for the CSI reporting is active; otherwise, the CSI reporting may be suspended.

A UE may not expect to report the CSI with a total number of UCI bits and CRC bits larger than 115 bits when configured with the PUCCH format 4. For the CSI reports transmitted on a PUCCH, if each CSI report includes one part, the UE may omit a portion of the CSI report according to the priority order determined from the Prii,CSI(y,k,c,s) value. The CSI report may be omitted beginning with the lowest priority level until the CSI report code rate is less or equal to the one configured by the higher layer parameter maxCodeRate.

In a case that a CSI report includes two parts, the UE may omit a portion of Part 2 CSI according to the priority order. Part 2 CSI may be omitted beginning with the lowest priority level until the Part 2 CSI code rate is less than or equal to the one configured by a higher layer parameter maxCodeRate.

L1/L2 triggered mobility (LTM) has been introduced to reduce the handover latency.

In some implementations, measurement report(s) triggered by a UE, and/or triggered by one or more specific conditions/events, may be taken into consideration while determining the L1/L2 triggered mobility. When a UE supports measurement report(s) triggered by the UE and/or triggered by one or more specific conditions/events, the manner of transmitting the measurement report may be taken into consideration. Moreover, how to simultaneously handle transmission(s) of legacy UL (e.g., PUSCH, and/or PUCCH, CSI report) and transmission(s) of the measurement report triggered by the UE and/or triggered by one or more specific conditions/events may be further determined.

In the present disclosure, a UE/event triggering report that addresses signaling overhead and enhances the transmission efficiency, and L1/L2 triggered mobility (LTM) that addresses the CSI reporting latency and that reduces CSI the reporting latency are provided. It should be noted that the measurement report may refer to, but not limited to, an L1 measurement report. It should also be noted that measurement report(s) triggered by a UE may imply that the UE may trigger the measurement report(s) (at anytime) irrespective of one or more conditions being met. Also, measurement report(s) triggered by one or more specific conditions/events may imply that the UE may trigger the measurement report(s) when one or more specific conditions are satisfied and/or some specific events are occurred.

In some implementations, the UE/event triggering report may be used to provide the L1 measurement results to the source cell/gNB during an LTM procedure. In some implementations, some measurements results may not be helpful for a network, thus the UE may not need to report such measurements results to the network. In some implementations, the UE/event triggering report may reduce the signaling overhead since the UE may (only) transmit helpful measurements results when some certain events/conditions are fulfilled. In other words, the UE may not transmit the measurements results when some events/conditions are not fulfilled, resulting in the reduction of the signaling overhead.

In some implementations, a UE may transmit the scheduling request (SR) to request UL resource(s).

In some implementations, in a case that a UE/event triggering report is triggered by a UE, the UE may transmit a UL signal to a network (e.g., for requesting physical resource(s), such as UL grant, time-frequency resources to transmit the report). The UE may receive/detect/monitor, from the network, DL signaling that indicates/schedules specific information. Specifically, the UE may receive/detect/monitor, from the network, DL signaling which is in response to the transmission of the UL signal to the network.

The specific information may include, but not limit to, a UL resource for the UE/event triggering report. The UE may transmit the UE/event triggering report on the UL resource. The UE/event triggering report may be triggered (or may start) when one or more conditions/events are satisfied/fulfilled.

The UL signal may be UCI (e.g., an SR) requesting the UL resource. In a case that the UL signal is an SR, the SR may be associated with a specific SR request ID, a specific SR resource ID, a specific PUCCH resource ID, and/or a specific logical channel configuration for the LTM. One or more candidate cells may be associated with an SR request ID and/or each candidate cell may be associated with an SR request ID. The target cell may be associated with an SR request ID.

An SR-for-LTM may refer to an SR with its ID=0, an SR with its configuration ID=0, an SR configuration with the lowest ID, or an SR configuration with the highest ID. The SR-for-LTM may be transmitted to a source cell, one or more candidate cells, and/or a target cell. The DL signaling may include DCI and/or a PDCCH. The UE may receive the DL signaling from the source cell and/or serving cell. The DCI may be a UL grant (e.g., DCI format 0_0/0_1/0_2) for scheduling UL transmission(s). The UL resource may be a PUSCH, a PUCCH, and/or a PUSCH carrying a Medium Access Control (MAC) Control Element (CE). The SR-for-LTM may be used to request the UL resource for the serving cell, candidate cell, and/or target cell.

In some implementations, SR-for-LTM may have the highest priority over the other SRs. For example, in a case that an SR-for-LTM overlaps with a normal SR, the normal SR may be dropped.

In some implementations, SR-for-LTM may have the lowest priority over the other SRs. For example, in a case that a normal SR overlaps with an SR-for-LTM, the SR-for-LTM may be dropped.

In some implementations, a UE may not transmit the SR-for-LTM for requesting a UL resource.

In some implementations, a UE may be configured with one or more configured UL resources by the source cell via RRC signaling. The RRC signaling may include RRC pre-configuration, RRC reconfiguration, RRC configuration, and/or RRC parameter. The one or more configured UL resources may be periodic, semi-persistent, and/or aperiodic UL resource(s).

Specifically, when a UE/event triggering report is triggered by a UE, the UE may transmit the UE/event triggering report on the one or more configured UL resources. The UE may transmit the UE/event triggering report on a configured UL resource. The configured UL resource may be the UL resource of which the start/end point is closest to a point of time when one or more events have occurred. The configured UL resource may be one of the one or more configured UL resources. The configured UL resource of which the start/end point may be after the point of time when one or more events occur.

In some implementations, the RRC signaling may include information associated with the UL resource for the serving cell, source cell and/or the candidate cells, where the information may include time/frequency domain resource allocation, periodicity, mcs-table, power control information, and/or timer configuration.

In some implementations, a UE/event triggering report may be transmitted on a MAC CE. The MAC CE may be transmitted in a UL resource. In some implementations, the UE may transmit an SR for requesting the UL resource. In some implementations, the UL resource may not be requested by the UE by transmitting the SR. For example, the UL resource may be configured via RRC signaling.

In some implementations, a MAC CE may be used for the UE/event triggering report. In other words, the UE may transmit the MAC CE as a UE/event triggering report to the serving cell and/or source cell. The MAC CE may include at least one of beam report information, measurement report information of source cell, serving cell, target cell, one or more candidate cells, and/or the CSI report.

The beam report information may include at least one of the following:
a serving cell beam report (e.g., which may be N CSI-RS/SSB associated with top-N highest measurement reports information);
a non-serving cell beam report (e.g., which may be N CSI-RS/SSB associated with top-N highest measurement reports information);
Transmission Configuration Indicator (TCI) states for serving cell;
TCI states for one or more candidate cells;
one or more candidate cell(s) beam report (e.g., for each candidate cell which may be N CSI-RS/SSB associated with top-N highest measurement reports information);
one or more target cell(s) beam report (e.g., which may be N CSI-RS/SSB associated with top-N highest measurement reports information); and/or
a source cell beam report (e.g., which may be N CSI-RS/SSB associated with top-N highest measurement reports information).

The measurement report information may include at least one of the following:
non-filtered Layer 1 results;
SSB based L1-RSRP;
SSB based L1-SINR;
SSB based L1-RSRQ;
CSI-RS based L1-RSRP;
CSI-RS based L1-SINR;
CSI-RS based L1-RSRQ;
filtered Layer 1 results; and/or
cell quality.

The CSI report may include at least one of:
Channel Quality Indicator (CQI);
L1-RSRP;
precoding matrix indicator (PMI);
CSI-RS resource indicator (CRI);
SS/PBCH Block Resource indicator (SSBRI);
layer indicator (LI);
rank indicator (RI);
CapabilityIndex;
one or more candidate cells ID;
target cell ID;
one or more BWP IDs for one or more candidate cells,
Physical Cell Identifier (PCI) of the serving cell/source cell;
PCI(s) of the candidate target cell(s), and/or
BWP ID for target cell.

In some implementations, a UE/event triggering report may be transmitted on the UCI. The UCI may be transmitted in a UL resource (e.g., PUCCH). In some implementations, the UE may transmit an SR for requesting the UL resource. In some implementations, the UL resource may not be requested by the UE by transmitting the SR. For example, the UL resource may be configured via RRC signaling.

In some implementations, the UCI may be used for the UE/event triggering report. In other words, the UE may transmit the UCI as a UE/event triggering report to the serving cell and/or source cell. The UCI may include at least one of beam report information, measurement report information of source cell, serving cell, target cell, one or more candidate cells, and/or the CSI report.

The beam report information may include at least one of the following:
serving cell beam report;
non-serving cell beam report;
one or more candidate cell(s) beam report;
one or more target cell(s) beam report; and/or
source cell beam report.

The measurement report information may include at least one of the following:
non-filtered Layer 1 results;
SSB based L1-RSRP;
SSB based L1-SINR;
SSB based L1-RSRQ;
CSI-RS based L1-RSRP;
CSI-RS based L1-SINR;
CSI-RS based L1-RSRQ;
filtered Layer 1 results; and/or
cell quality.

The CSI report may include at least one of the following:
Channel Quality Indicator (CQI);
L1-RSRP;
precoding matrix indicator (PMI);
CSI-RS resource indicator (CRI);
SS/PBCH Block Resource indicator (SSBRI);
layer indicator (LI);
rank indicator (RI);
CapabilityIndex;
one or more candidate cells ID;
target cell ID;
one or more BWP IDs for one or more candidate cells;
PCI of the serving cell/source cell;
PCI(s) of the candidate target cell(s); and/or
BWP ID for target cell ID.

In some implementations, in a case that one or more UE/event triggering report conditions/events are satisfied/fulfilled, a UE may transmit the UE/event triggering report in a UL resource.

In some implementations, in a case that one or more UE/event triggering report conditions/events are satisfied/fulfilled and a UE is not configured with a UL resource for UE/event triggering report, the UE may not transmit the UE/event triggering report.

In some implementations, in a case that one or more UE/event triggering report conditions/events are satisfied/fulfilled and a UE is not configured with a UL resource for UE/event triggering report, the UE may transmit an SR for requesting the UL resource.

In some implementations, the UE may be configured with a UL resource for UE/event triggering report, therefore the UE may not transmit an SR for requesting the UL resource.

The UE/event triggering report conditions may include at least one of the following:
measurement result of a serving (or source) cell becomes better than a threshold;
measurement result of a serving (or source) cell becomes worse than a threshold;
measurement result(s) of a neighboring cell (or one or more candidate cells, or a target cell) become offset better than that of a Special Cell (SpCell) (or a source cell, or a serving cell);
measurement result(s) of a neighboring cell (or one or more candidate cells, or a target cell) become better than a threshold;
measurement result of a SpCell (or a source cell, or a serving cell) becomes worse than a first threshold, and measurement result(s) of a neighboring cell (or one or more candidate cells, or a target cell) become better than a second threshold; and/or
measurement result(s) of a neighboring cell (or one or more candidate cells, or a target cell) may become offset better than that of SCell (or a source cell, or a serving cell).

In some implementations, the UE may be configured with any one of the thresholds described above (e.g., including the first threshold, and/or the second threshold). In some implementations, the UE may be indicated any one of the thresholds described above (e.g., including the first threshold, and/or the second threshold) by DCI.

In some implementations, the measurement result may include at least one of: non-filtered Layer 1 results, L1-RSRP report, filtered Layer 1 results and/or cell quality.

In some implementations, type of the threshold (e.g., the metric of the threshold) may be aligned with that of the measurement result. For example, in a case that the measurement result is L1-RSRP report, the type of threshold may be an RSRP; in a case that the measurement result is L1-SINR report, the type of threshold may be an SINR.

In some implementations, a UE may not expect that a first UE/event triggering report (e.g., for a first candidate cell) and a second UE/event triggering report (e.g., for a second candidate cell) overlap (e.g., in time and/or frequency).

In some implementations, in a case that a first UE/event triggering report (e.g., for a first candidate cell) and a second UE/event triggering report (e.g., for a second candidate cell) overlap (e.g., in time and/or frequency), the UE may multiplex the first and second UE/event triggering reports and transmit the multiplexed first and second UE/event triggering reports in a UL resource. In some implementations, the UL resource that is used may be the earlier one of the two UL resources for the first UE/event triggering report and the second UE/event triggering report. In some implementations, the UL resource that is used may be the later one of the two UL resources for the first UE/event triggering report and the second UE/event triggering report.

In some implementations, a UE may be configured with two CSI report configurations for UE/event triggering report and (e.g., network triggering) CSI report, respectively.

In some implementations, a UE may be configured with a first configuration associated with the UE/event triggering report and/or a second configuration associated with (e.g., network triggering) CSI report. The first and/or second configuration may be associated with one or more of the following parameters: CSI-MeasConfig, CSI-ResourceConfig, CSI-ReportConfig, CSI configuration in RRC pre-configuration, and/or configuration for LTM.

The IE CSI-MeasConfig may be used to configure the CSI-RS (reference signals) that belong to the serving cell in which the CSI-MeasConfig is included, the channel state information reports that are to be transmitted on a PUCCH on the serving cell in which the CSI-MeasConfig is included, and the channel state information reports on the PUSCH that are triggered by the DCI received on the serving cell in which the CSI-MeasConfig is included.

The IE CSI-ResourceConfig may define a group of one or more NZP-CSI-RS-ResourceSet, CSI-IM-ResourceSet, and/or CSI-SSB-ResourceSet.

The IE CSI-ReportConfig may be used to configure a periodic or semi-persistent report to be transmitted on a PUCCH on the cell in which the CSI-ReportConfig is included, or to configure a semipersistent or aperiodic report to be transmitted on a PUSCH triggered by the DCI received on the cell in which the CSI-ReportConfig is included. In a case that the CSI-ReportConfig is used to configure a semipersistent or aperiodic report to be transmitted on the PUSCH triggered by the DCI received on the cell in which the CSI-ReportConfig is included, the cell for the report transmission may be determined by the received DCI.

The UE may be configured with one or more first UL resources for the UE/event triggering report. The UE may be configured with one or more second UL resources for (e.g., network triggering) the CSI report. The one or more first UL resources for the UE/event triggering report may be periodic, semi-persistent, and/or aperiodic. The one or more second UL resources for the UE/event triggering report may be periodic, semi-persistent, and/or aperiodic.

The UE may transmit the UE/event triggering report based on the first configuration and transmit the (e.g., network triggering) CSI report based on the second configuration. The first configuration may be associated with the one or more first UL resources and the second configuration may be associated with the one or more second UL resources.

The CSI-ReportConfig may include a reportConfigType (e.g., periodic, semiPersistentOnPUCCH, semiPersistentOnPUSCH, and/or aperiodic), a reportConfigld, carrier, a resourcesForChannelMeasurement, a csi-IM-ResourcesForInterference, an nzp-CSI-RS-ResourcesForInterference, a reportFreqConfiguration, and/or a reportQuantity (e.g., more details may be found in 3GPP TS 38.331 V17.2.0).

The one or more first UL resources and/or the one or more second UL resources may be associated with the reportConfigType which is periodic, semiPersistentOnPUCCH, semiPersistentOnPUSCH, or aperiodic. In a case that the reportConfigType is periodic and/or semiPersistentOnPUCCH, the UE may transmit the UE/event triggering report and/or the (e.g., network triggering) CSI report on a PUCCH resource configured by the pucch-CSI-ResourceList/pucch-CSI-Resource. In a case that the reportConfigType is aperiodic and/or semiPersistentOnPUSCH, the UE may receive/detect a PDCCH with a DCI and transmit the UE/event triggering report and/or the (e.g., network triggering) CSI report on a PUSCH resource indicated by the DCI.

A UE may perform aperiodic CSI reporting using PUSCH upon successful decoding of a DCI format 0_1 or DCI format 0_2 which triggers an aperiodic CSI trigger state.

In some implementations, a UE/event triggering report may overlap (e.g., in time and/or in frequency) a (e.g., network triggering) CSI report.

In some implementations, in a case that a UE is configured with (or enable) a first configuration associated with a UE/event triggering report and a second configuration associated with a (e.g., network triggering) CSI report, and a first UL resource for the UE/event triggering report overlaps (e.g., in time and/or in frequency) a second UL resource for the (e.g., network triggering) CSI report, the UE may perform at least one of the following:
the UE may multiplex the report for the first UL resource into the second UL resource;
the UE may multiplex the report for the first UL resource into the second UL resource when a timeline requirement is met;
the UE may multiplex the report for the second UL resource into the first UL resource;
the UE may multiplex the report for the second UL resource into the first UL resource when a timeline requirement is met;
the UE may transmit the UE/event triggering report on the first UL resource (e.g., the UE may cancel the CSI report for the second UL resource);
the UE may transmit the (e.g., network triggering) CSI report on the second UL resource (e.g., the UE may cancel the UE/event triggering report for the first UL resource);
the UE may transmit either the UE/event triggering report in the first UL resource or the (e.g., network triggering) CSI report in the second UL resource according to a priority, where the priority may be configured for transmitting UE/event triggering report or (e.g., network triggering) CSI report, and may be configured by a source/serving cell of the UE (e.g., via RRC preconfiguration, via the reception of an RRC message from the source/serving cell, via the reception of an MAC CE from the source/serving cell);
the UE may not expect the first UL resource for the UE/event triggering report would overlap (e.g., in time and/or in frequency) with the second UL resource for the (e.g., network triggering) CSI report;
the UE may postpone the transmission of the UE/event triggering report to the next available UL resource; and/or
the UE may postpone the transmission of the (e.g., network triggering) CSI report to the next available UL resource.

The first UL resource may be a PUCCH, a PUSCH, and/or a PUSCH carrying a MAC CE. The second UL resource may be a PUCCH, a PUSCH, and/or a PUSCH carrying a MAC CE.

In some implementations, the UE may transmit an SR to the network (e.g., for requesting the second UL resource) after the UE/event triggering report is triggered or at least one of the conditions for the UE/event triggering report is satisfied. The second UL resource may be indicated/scheduled by a DCI. The second UL resource may be, for example, the UL resource of which the start/end point of time is closest to the time when the UE/event triggering report is triggered, the time when the at least one of the conditions for the UE/event triggering report is satisfied, or the time when at least one of the conditions/events occur. The second UL resource may be one of the configured UL resources associated with the second configuration. The second UL resource may be a UL resource of which the start/end point of time is after the time when the UE/event triggering report is triggered or at least one of the conditions for the UE/event triggering report occurs.

In some implementations, the UE/event triggering CSI report may be transmitted on a UL resource for the (e.g., network triggering) CSI report.

In some implementations, a UE may be configured with a second configuration associated with a (e.g., network triggering) CSI report. The second configuration may be associated with one or more of the following parameters: CSI-MeasConfig, CSI-ResourceConfig, and/or CSI-ReportConfig.

The UE may be configured with one or more second UL resources for the (e.g., network triggering) CSI report. The one or more second UL resources for UE/event triggering report may be periodic, semi-persistent, and/or aperiodic. The UE may transmit the (e.g., network triggering) CSI report based on the second configuration, and the second configuration may be associated with the one or more second UL resources.

The CSI-ReportConfig may include a reportConfigType (e.g., periodic, semiPersistentOnPUCCH, semiPersistentOnPUSCH, and/or aperiodic), a reportConfigld, carrier, resourcesForChannelMeasurement, a csi-IM-ResourcesForInterference, an nzp-CSI-RS-ResourcesForInterference, a reportFreqConfiguration, and/or a reportQuantity.

The one or more second UL resources may be associated with the reportConfigType which is periodic, semiPersistentOnPUCCH, semiPersistentOnPUSCH, or aperiodic. In a case that the reportConfigType is configured with periodic and/or semiPersistentOnPUCCH, the UE may transmit the (e.g., network triggering) CSI report on a PUCCH resource configured by the pucch-CSI-ResourceList/pucch-CSI-Resource. In a case that the reportConfigType is configured with aperiodic and/or semiPersistentOnPUSCH, the UE may receive/detect a PDCCH with a DCI and transmit the (e.g., network triggering) CSI report on a PUSCH resource indicated by the DCI.

In some implementations, when a UE/event triggering report is triggered, the UE may transmit a UL signal to a network. The UE may be configured with a second configuration associated with a (e.g., network triggering) CSI report. The UE may be configured with one or more second UL resources for the CSI report. The one or more second UL resources for the UE/event triggering report may be periodic, semi-persistent, and/or aperiodic. The UE may receive/detect/monitor DL signaling from the network, where the DL signaling indicates/schedules a UL resource for the UE/event triggering report. The UE may transmit the UE/event triggering report on the indicated/scheduled UL resource which is one of the one or more second UL resources.

The indicated/scheduled UL resource may be a PUCCH, a PUSCH, and/or a PUCSH carrying a MAC CE. The indicated/scheduled UL resource may be periodic, semi-persistent, and/or aperiodic. The MAC CE may be transmitted on the indicated/scheduled UL resource. The DL signaling may be a DCI with a specific field indicating one of the second one or more UL resources for transmitting the UE/event triggering report.

In some implementations, a UE may be configured (or enable) a second configuration including one or more second UL resources associated with the (e.g., network triggering) CSI report. In a case that a first UL resource for the UE/event triggering report is indicated/scheduled by DCI, and the first UL resource is one of the one or more second UL resources for the (e.g., network triggering) CSI report, the UE may perform at least one of the following:
the UE may multiplex information of the UE/event triggering report and information of the (e.g., network triggering) CSI report;
the UE may transmit the UE/event triggering report and the network triggering) CSI report (e.g., multiplexing of the reports) on the first UL resource;
the UE may transmit the UE/event triggering report on the first UL resource (e.g., the UE may cancel the (e.g., network triggering) CSI report for the first UL resource);
the UE may transmit the (e.g., network triggering) CSI report on the first UL resource (e.g., the UE may cancel the UE/event triggering report for the first UL resource); and/or
the UE may transmit either the UE/event triggering report or the (e.g., network triggering) CSI report according to a priority, where the priority may be configured for transmitting the UE/event triggering report or the (e.g., network triggering) CSI report on the first UL resource, and configured by a source/serving cell to the UE (e.g., via RRC preconfiguration, via the reception of an RRC message from the source/serving cell).

In some implementations, when a UE/event triggering report is triggered, and the UE is configured with one or more second UL resources for the (e.g., network triggering) CSI report, the UE may transmit the UE/event triggering report on a first UL resource which is one of the one or more second UL resources. The first UL resource may be a UL resource of which the start/end point of time is closest to the time when one or more events/conditions occurs. The first UL resource may be a UL resource of which the start/end point of time is after the occurrence of the one or more events.

In some implementations, a UE may be configured with (or enable) a second configuration including one or more second UL resources associated with the (e.g., network triggering) CSI report. In a case that one or more events/conditions occur, a first UL resource is one of the one or more second UL resources for the (e.g., network triggering) CSI report, and the start/end point of time of the first UL resource is closest to the time when the one or more events/conditions occur, the UE may perform at least one of the following:
the UE may multiplex information of the UE/event triggering report and information of the (e.g., network triggering) CSI report;
the UE may transmit the UE/event triggering report and the (e.g., network triggering) CSI report (e.g., multiplexing of the reports) on the first UL resource;
the UE may transmit the UE/event triggering report on the first UL resource (e.g., the UE may cancel the (e.g., network triggering) CSI report for the first UL resource);
the UE may transmit the (e.g., network triggering) CSI report on the first UL resource (e.g., the UE may cancel the UE/event triggering report for the first UL resource); and/or
the UE may transmit either the UE/event triggering report or the (e.g., network triggering) CSI report according to a priority, where the priority may be configured for transmitting the UE/event triggering report or the (e.g., network triggering) CSI report on the first UL resource.

In some implementations, a PUCCH may overlap with another PUCCH that carries a UE/event triggering report.

In some implementations, a UE is configured with a first configuration associated with the UE/event triggering report. The first configuration may be associated with one or more of the following parameters: CSI-MeasConfig, CSI-ResourceConfig, and/or CSI-ReportConfig.

The UE may be configured with one or more first UL resources for UE/event triggering report. The one or more first UL resources for the UE/event triggering report may be periodic, semi-persistent, and/or aperiodic. The UE may transmit the UE/event triggering report based on the first configuration and the first configuration may be associated with the one or more first UL resources.

The CSI-ReportConfig may include a reportConfigType (e.g., periodic, semiPersistentOnPUCCH, semiPersistentOnPUSCH, and/or aperiodic), a reportConfigld, carrier, resourcesForChannelMeasurement, a csi-IM-ResourcesForInterference, an nzp-CSI-RS-ResourcesForInterference, a reportFreqConfiguration, and/or a reportQuantity.

The one or more first UL resources may be associated with the reportConfigType which is periodic, semiPersistentOnPUCCH, semiPersistentOnPUSCH, or aperiodic. In a case that the reportConfigType is configured with periodic and/or semiPersistentOnPUCCH (e.g., more details may be found in 3GPP TS 38.331 V17.2.0), the UE may transmit the UE/event triggering report on one of the one or more first UL resources which may be a PUCCH.

In some implementations, in a case that a first UL resource, which is a first PUCCH, for transmitting the UE/event triggering report overlaps (e.g., in time and/or in frequency) with one or more second PUCCHs, the UE may perform at least one of the following:
the UE may multiplex information for the UE/event triggering report and information for the one or more second PUCCHs;
the UE may transmit the UE/event triggering report and information for the one or more second PUCCHs on the first UL resource;
the UE may multiplex information for the UE/event triggering report and information for the one or more second PUCCHs in a case that the information for the one or more second PUCCHs does not include a (e.g., network triggering) CSI report;
the UE may transmit the UE/event triggering report and information for the one or more second PUCCHs on one of the one or more second PUCCHs;
the UE may multiplex information for the UE/event triggering report into each of the one or more second PUCCHs;
the UE may transmit the UE/event triggering report on the first UL resource (e.g., the UE may cancel the information for the one or more second PUCCHs);
the UE may transmit information on the one or more second PUCCHs (e.g., the UE may cancel the UE/event triggering report);
the UE may transmit either the UE/event triggering report or information for the one or more second PUCCHs according to a priority, where the priority may be configured for transmitting the UE/event triggering report or the information for the one or more second PUCCHs on the first UL resource.
the UE may transmit either the UE/event triggering report or information for the one or more second PUCCHs according to a priority, where the priority may be configured for transmitting the UE/event triggering report or the information for the one or more second PUCCHs on the one or more second PUCCHs.

In some implementations, in a case that the UE does not transmit the UE/event triggering report (e.g., according to the priority), the UE may cancel the UE/event triggering report.

In some implementations, in a case that the UE does not transmit the information for the one or more second PUCCHs (e.g., according to the priority), the UE may cancel the information for the one or more second PUCCHs.

In some implementations, a PUCCH may overlap with a PUSCH that carries a UE/event triggering report.

In some implementations, a UE is configured with a first configuration associated with the UE/event triggering report. The first configuration may be associated with one or more of the following parameters: CSI-MeasConfig, CSI-ResourceConfig, and/or CSI-ReportConfig.

The UE may be configured with one or more first UL resources for UE/event triggering report. The one or more first UL resources for the UE/event triggering report may be periodic, semi-persistent, and/or aperiodic. The UE may transmit the UE/event triggering report based on the first configuration and the first configuration may be associated with the one or more first UL resources.

The CSI-ReportConfig may include a reportConfigType (e.g., periodic, semiPersistentOnPUCCH, semiPersistentOnPUSCH, and/or aperiodic), a reportConfigld, carrier, resourcesForChannelMeasurement, a csi-IM-ResourcesForInterference, an nzp-CSI-RS-ResourcesForInterference, a reportFreqConfiguration, and/or a reportQuantity (e.g., more details may be found in 3GPP TS 38.331 V17.2.0).

The one or more first UL resources may be associated with the reportConfigType which is periodic, semiPersistentOnPUCCH, semiPersistentOnPUSCH, or aperiodic. In a case that the reportConfigType is configured with aperiodic and/or semiPersistentOnPUSCH, the UE may receive/detect a PDCCH with a DCI and transmit the UE/event triggering report on one of the one or more first UL resources which is a PUSCH resource indicated by the DCI.

In some implementations, in a case that a first UL resource, which is a PUSCH, for transmitting the UE/event triggering report overlaps (e.g., in time and/or in frequency) with one or more PUCCHs, the UE may perform at least one of the following:
the UE may postpone information for the UE/event triggering report;
the UE may postpone information for the one or more PUCCHs;
the UE may multiplex information of the UE/event triggering report and information for the one or more PUCCHs;
the UE may multiplex information of the UE/event triggering report and information for one of the one or more PUCCHs;
the UE may multiplex information of the UE/event triggering report and information for the one or more PUCCHs in a case that the information for the one or more PUCCHs does not include a (e.g., network triggering) CSI report;
the UE may transmit the UE/event triggering report and information for the one or more PUCCHs on the PUSCH;
the UE may transmit the UE/event triggering report on the first UL resource (e.g., the UE may cancel the information for the one or more PUCCHs); and/or
the UE may transmit information for the one or more PUCCHs (e.g., the UE may cancel the UE/event triggering report).

In some implementations, a PUSCH may overlap with a PUCCH that carries a UE/event triggering report.

In some implementations, a UE is configured with a first configuration associated with the UE/event triggering report. The first configuration may be associated with one or more of the following parameters: CSI-MeasConfig, CSI-ResourceConfig, and/or CSI-ReportConfig.

The UE may be configured with one or more first UL resources for UE/event triggering report. The one or more first UL resources for the UE/event triggering report may be periodic, semi-persistent, and/or aperiodic. The UE may transmit the UE/event triggering report based on the first configuration and the first configuration may be associated with the one or more first UL resources.

The CSI-ReportConfig may include a reportConfigType (e.g., periodic, semiPersistentOnPUCCH, semiPersistentOnPUSCH, and/or aperiodic), a reportConfigld, carrier, resourcesForChannelMeasurement, a csi-IM-ResourcesForInterference, an nzp-CSI-RS-ResourcesForInterference, a reportFreqConfiguration, and/or a reportQuantity (e.g., more details may be found in 3GPP TS 38.331 V17.2.0).

The one or more first UL resources may be associated with the reportConfigType which is periodic, semiPersistentOnPUCCH, semiPersistentOnPUSCH, or aperiodic. In a case that the reportConfigType is configured periodic and/or semiPersistentOnPUCCH, the UE may transmit the UE/event triggering report on one of the one or more first UL resources which may be a PUCCH.

In some implementations, in a case that a first UL resource, which is a PUCCH, for transmitting the UE/event triggering report overlaps (e.g., in time and/or in frequency) with one or more PUSCHs, the UE may perform at least one of the following:
the UE may postpone information of the UE/event triggering report;
the UE may postpone information for the one or more PUCCHs;
the UE may multiplex information of the UE/event triggering report and information for the one or more PUSCHs;
the UE may multiplex information of the UE/event triggering report and information for the one or more PUSCHs in a case that the information for the one or more PUSCHs does not include a (e.g., network triggering) CSI report;
the UE may transmit the UE/event triggering report and information for the one or more PUSCHs on one of the one or more PUSCHs;
the UE may multiplex information of the UE/event triggering report into each of the one or more PUSCHs;
the UE may transmit the UE/event triggering report on the first UL resource (e.g., the UE may cancel the information for the one or more PUSCHs); and/or
the UE may transmit information for the one or more PUSCHs (e.g., the UE may cancel the UE/event triggering report).

When one or more triggering conditions is/are fulfilled, or one or more triggering events occur, the UE may transmit a UL signal to a network. After transmitting the UL signal to the network, the UE may receive/detect/monitor a DL signaling from the network, where the DL signaling may indicate/schedule one or more information, and the one or more information may include a UL resource for the UE to transmit a UE/event triggering report. When the UE/event triggering report overlaps with one or more UL resources, the UE may multiplex the UE/event triggering report into one of the one or more UL resources, where the one or more UL resources may include a PUCCH for UCI, a PUCCH for CSI report, a PUSCH, and/or a PUSCH for CSI report.

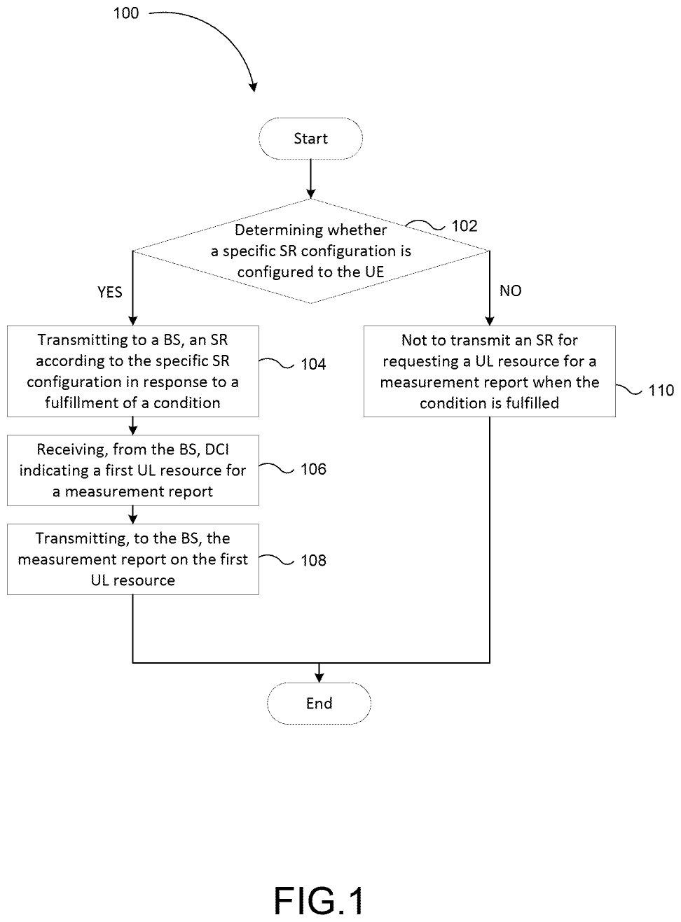

FIG. 1 is a flowchart for a method/process 100 of event triggering measurement report, according to an example implementation of the present disclosure. In some embodiment the process 100 may be performed by a UE. It should be noted that although actions 102, 104, 106, 108 and 110 are illustrated as separate actions represented as independent blocks in FIG. 1, these separately illustrated actions should not be construed as necessarily order-dependent. The order in which the actions are performed in FIG. 1 is not intended to be construed as a limitation, and any number of the disclosed blocks may be combined in any order to implement the method, or an alternate method. Moreover, each of actions 102, 104, 106, 108, and 110 may be performed independently of other actions and may be omitted in some implementations of the present disclosure.

In action 102, the process 100 may determine whether a specific scheduling request (SR) configuration is configured to the UE. In a case that the specific SR configuration is configured to the UE, the process 100 may proceed to action 104, otherwise, the process 100 may proceed to action 110.

In some implementations, the specific SR configuration may include an SR configuration associated with an L1/L2 Triggered Mobility (LTM) mechanism. For example, the specific SR configuration may be used to configure an SR-for LTM.

In some implementations, the SR configuration associated with the LTM mechanism may include an SR configuration for event triggering measurement reporting, such that the UE may transmit an SR to the BS for requesting a UL resource for a measurement repot in response to a fulfilment of the condition(s) for the event triggering measurement reporting.

In some implementations, the specific SR configuration may have a configuration ID=0.

In action 104, in response to at least one condition being fulfilled/satisfied/met (e.g., a condition for the event triggering measurement reporting), the process 100 may transmit, to a base station (BS), an SR according to the specific SR configuration.

In some implementations, the condition(s) for the event triggering measurement reporting may be fulfilled in a case that a measurement result indicates that a signal quality of at least one candidate cell is better than a signal quality of the serving cell.

In some implementations, the condition(s) for the event triggering measurement reporting may be fulfilled in a case that a measurement result indicates that a signal quality of at least one candidate cell is offset better than a signal quality of the serving cell, e.g., the signal quality of at least one candidate cell exceeds the signal quality of the serving cell by more than a predetermined threshold.

In some implementations, the condition(s) for the event triggering measurement reporting may be fulfilled in a case that a measurement result indicates that a signal quality of the serving cell is worse than a predetermined threshold.

In some implementations, the condition(s) for the event triggering measurement reporting may be associated with a non-filtered Layer 1 measurement result with respect to the serving cell. For example, the measurement result indicating the signal quality of the candidate cell(s)/serving cell, as described above, may be the non-filtered Layer 1 measurement result.

In action 106, the process 100 may receive DCI from the BS, where the DCI may indicate a first UL resource for a measurement report. In action 108, the process 100 may transmit, to the BS, the measurement report on the first UL resource.

In some implementations, the first UL resource may overlap with one or more second UL resources configured to the UE. The one or more second UL resource may be configured for transmitting any contents.

In some implementations, before action 108, the process 100 may first determine whether the first UL resource overlaps with a second UL resource (e.g., which may be configured to transmit a content).

In some implementations, in a case that the first UL resource overlaps with a second UL resource, the process 100 may transmit the measurement report on the first UL resource.

In some implementations, in a case that the first UL resource overlaps with a second UL resource, the process 100 may transmit the measurement report on the second UL resource.

In some implementations, in a case that the first UL resource overlaps with a second UL resource which is configured to transmit a content, the process 100 may transmit the content on the first UL resource.

In some implementations, in a case that the first UL resource overlaps with a second UL resource which is configured to transmit the content, the process 100 may transmit the content on the second UL resource.

In some implementations, in a case that the first UL resource overlaps with a second UL resource which is configured to transmit a content, the process 100 may transmit a multiplexing of the measurement report and the content on the first UL resource.

In some implementations, in a case that the first UL resource overlaps with a second UL resource which is configured to transmit a content, the process 100 may transmit a multiplexing of the measurement report and the content on the second UL resource.

In action 110, as the specific SR configuration is not configured to the UE, the process 100 may not transmit an SR for requesting a UL resource for a measurement report even when condition(s) for the event triggering measurement report are fulfilled.

Based on the above, the measurement report may be initiated/triggered by the UE in response to a fulfilment of the condition(s) for the event triggering measurement reporting.

It should be noted that in the present disclosure, the BS may perform methods/actions corresponding to those performed by the UE. For example, the receiving actions performed by the UE may correspond to the transmitting/configuring actions of the BS; the transmitting actions performed by the UE may correspond to the receiving actions of the BS. That is, the BS and the UE may have reciprocally aligned roles in transmission and reception. Consequently, the methods or actions executed by the BS may be combined or integrated in a similar manner to how the methods or actions are executed by the UE.

For example, when viewed from the BS's perspective, the method illustrated with reference to FIG. 1 may correspond to a method performed by the BS. Specifically, the BS may transmit a specific SR configuration to the UE, where the specific SR configuration may be an SR configuration for event triggering measurement reporting. Additionally, the BS may receive an SR associated with the specific SR configuration from the UE. In response thereto, the BS may transmit, to the UE, DCI indicating a first UL resource for a measurement report, and receive, from the UE, the measurement report on the first UL resource.

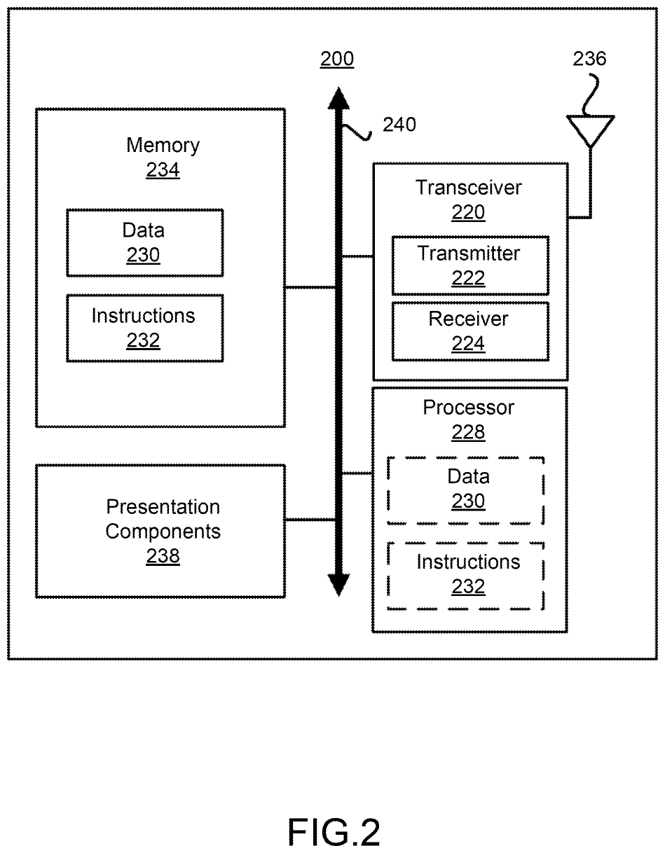

FIG. 2 is a block diagram illustrating a node 200 for wireless communication, according to an example implementation of the present disclosure. As illustrated in FIG. 2, a node 200 may include a transceiver 220, a processor 228, a memory 234, one or more presentation components 238, and at least one antenna 236. The node 200 may also include a radio frequency (RF) spectrum band module, a BS communications module, a NW communications module, and a system communications management module, Input/Output (I/O) ports, I/O components, and a power supply (not illustrated in FIG. 2).

Each of the components may directly or indirectly communicate with each other over one or more buses 240. The node 200 may be a UE or a BS that performs various functions disclosed with reference to FIG. 1.

The transceiver 220 has a transmitter 222 (e.g., transmitting/transmission circuitry) and a receiver 224 (e.g., receiving/reception circuitry) and may be configured to transmit and/or receive time and/or frequency resource partitioning information. The transceiver 220 may be configured to transmit in different types of subframes and slots including, but not limited to, usable, non-usable and flexibly usable subframes and slot formats. The transceiver 220 may be configured to receive data and control channels.

The node 200 may include a variety of computer-readable media. Computer-readable media may be any available media that may be accessed by the node 200 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information, such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired NW or direct-wired connection, and wireless media, such as acoustic, RF, infrared, and other wireless media. Combinations of any of the previously listed components should also be included within the scope of computer-readable media.

The memory 234 may include computer-storage media in the form of volatile and/or non-volatile memory. The memory 234 may be removable, non-removable, or a combination thereof. Example memory may include solid-state memory, hard drives, optical-disc drives, etc. As illustrated in FIG. 2, the memory 234 may store a computer-readable and/or computer-executable instructions 232 (e.g., software codes or programs) that are configured to, when executed, cause the processor 228 to perform various functions disclosed herein, for example, with reference to FIG. 1. Alternatively, the instructions 232 may not be directly executable by the processor 228 but may be configured to cause the node 200 (e.g., when compiled and executed) to perform various functions disclosed herein.

The processor 228 (e.g., having processing circuitry) may include an intelligent hardware device, e.g., a Central Processing Unit (CPU), a microcontroller, an ASIC, etc. The processor 228 may include memory. The processor 228 may process the data 230 and the instructions 232 received from the memory 234, and information transmitted and received via the transceiver 220, the baseband communications module, and/or the NW communications module. The processor 228 may also process information to send to the transceiver 220 for transmission via the antenna 236 to the NW communications module for transmission to a Core Network (CN).

One or more presentation components 238 may present data indications to a person or another device. Examples of presentation components 238 may include a display device, a speaker, a printing component, a vibrating component, etc.

In view of the present disclosure, various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are considered in all respects as illustrative and not restrictive. It should also be understood that the present disclosure is not limited to the specific implementations disclosed. Still, many rearrangements, modifications, and substitutions are possible without departing from the scope of the present disclosure.

What is claimed is:

1. A method for event triggered measurement reporting performed by a user equipment (UE), the method comprising:
determining whether a specific scheduling request (SR) configuration is configured to the UE;
in a case that the specific SR configuration is configured to the UE, transmitting, to a base station (BS), an SR according to the specific SR configuration in response to a fulfillment of a condition;
receiving, from the BS, downlink control information (DCI) indicating a first uplink (UL) resource for transmitting a measurement report; and
transmitting, to the BS, the measurement report on the first UL resource.

2. The method of claim 1, wherein the specific SR configuration is associated with a Layer 1/Layer 2 (L1/L2) Triggered Mobility (LTM) mechanism.

3. The method of claim 1, wherein the specific SR configuration comprises an SR configuration for event triggered measurement reporting.

4. The method of claim 1, further comprising:
determining whether the first UL resource overlaps with a second UL resource that is configured to the UE for transmitting a content; and
in a case that the first UL resource overlaps with the second UL resource, transmitting, to the BS, the measurement report, the content, or a multiplexing of the measurement report and the content on the first UL resource or the second UL resource.

5. The method of claim 1, wherein the condition is associated with a non-filtered Layer 1 measurement result with respect to a serving cell.

6. The method of claim 5, wherein the condition is fulfilled in a case that the measurement result indicates that a signal quality of at least one candidate cell is better than a signal quality of the serving cell.

7. The method of claim 5, wherein the condition is fulfilled in a case that the measurement result indicates that a signal quality of at least one candidate cell exceeds a signal quality of the serving cell by more than a predetermined threshold.

8. The method of claim 5, wherein the condition is fulfilled in a case that the measurement result indicates that a signal quality of the serving cell is worse than a predetermined threshold.

9. A user equipment (UE), comprising:
one or more non-transitory computer-readable media storing one or more computer-executable instructions; and
at least one processor coupled to the one or more non-transitory computer-readable media, the at least one processor configured to execute the one or more computer-executable instructions to cause the UE to:
determine whether a specific scheduling request (SR) configuration is configured to the UE;
in a case that the specific SR configuration is configured to the UE, transmit, to a base station (BS), an SR according to the specific SR configuration in response to a fulfillment of a condition;
receive, from the BS, downlink control information (DCI) indicating a first uplink (UL) resource for transmitting a measurement report; and
transmit, to the BS, the measurement report on the first UL resource.

10. The UE of claim 9, wherein the specific SR configuration is associated with a Layer 1/Layer 2 (L1/L2) Triggered Mobility (LTM) mechanism.

11. The UE of claim 9, wherein the specific SR configuration comprises an SR configuration for event triggered measurement reporting.

12. The UE of claim 9, wherein the at least one processor is configured to execute the computer-executable instructions to further cause the UE to:
determine whether the first UL resource overlaps with a second UL resource that is configured to the UE for transmitting a content; and
in a case that the first UL resource overlaps with the second UL resource, transmit, to the BS, the measurement report, the content, or a multiplexing of the measurement report and the content on the first UL resource or the second UL resource.

13. The UE of claim 9, wherein the condition is associated with a non-filtered Layer 1 measurement result with respect to a serving cell.

14. The UE of claim 13, wherein the condition is fulfilled in a case that the measurement result indicates that a signal quality of at least one candidate cell is better than a signal quality of the serving cell.

15. The UE of claim 13, wherein the condition is fulfilled in a case that the measurement result indicates that a signal quality of at least one candidate cell exceeds a signal quality of the serving cell by more than a predetermined threshold.

16. The UE of claim 13, wherein the condition is fulfilled in a case that the measurement result indicates that a signal quality of the serving cell is worse than a predetermined threshold.

17. A base station (BS), comprising:
one or more non-transitory computer-readable media storing one or more computer-executable instructions; and
at least one processor coupled to the one or more non-transitory computer-readable media, the at least one processor configured to execute the one or more computer-executable instructions to cause the BS to:
transmit, to a user equipment (UE), a specific scheduling request (SR) configuration;
receive, from the UE, an SR associated with the specific SR configuration;
transmit, to the UE, downlink control information (DCI) indicating a first uplink (UL) resource for receiving a measurement report in response to a reception of the SR associated with the specific SR configuration; and
receive, from the UE, the measurement report on the first UL resource.

18. The BS of claim 17, wherein the specific SR configuration is associated with a Layer 1/Layer 2 (L1/L2) Triggered Mobility (LTM) mechanism.

19. The BS of claim 17, wherein the specific SR configuration comprises an SR configuration for event triggered measurement reporting.

20. The BS of claim 17, wherein the at least one processor is configured to execute the one or more computer-executable instructions to further cause the BS to:
transmit, to the UE, a configuration of a second UL resource for receiving a content; and
in a case that the first UL resource overlaps with the second UL resource, receive, from the UE, the measurement report, the content, or a multiplexing of the measurement report and the content on the first UL resource or the second UL resource.
